(19) United States
(12) Patent Application Publication
(10) Pub. No.: US 2007/0213646 A1
(43) Pub. Date: Sep. 13, 2007

(54) Pillow for Generating Vibration and a Negative Ion

(76) Inventor: Wan-Seok Han, Seoul (KR)

Correspondence Address: BIRCH STEWART KOLASCH & BIRCH, PO BOX 747, FALLS CHURCH, VA, 22040-0747, US

(21) Appl. No.: 11/587,696

(22) PCT Filed: Jun. 2, 2006
(86) PCT No.: PCT/KR06/02124

§ 371 Date: Oct. 26, 2006

(30) Foreign Application Priority Data
Jun. 2, 2005 (KR) 10-2005-0047464
May 26, 2006 (KR) 10-2006-0047389

(51) Int. Cl. A61H 1/00

(52) U.S. Cl. 601/57; 5/915; 5/636; 601/49

(57) ABSTRACT

The present relates to the functional semicircle pillar-shaped pillow which self-vibrating with a proper strength to massage the scalp and promote the blood circulation as well as self-generating a negative ion for a long time and purifying a circumstance air to make promotion of health, the semicircle pillar-shaped pillow of the present invention is characterizing in comprising the vibration generating part which is constructed by making a regular space in the inside of the pillow, and installing the vibration motor, and connecting the vibrator to the vibration motor; the protrusion part which is formed on regular sites of the vibrator, and protrude out of holes formed on the surface of the pillow with regular height; and the negative ion generating part in which the pad coating part is formed on the upper part of the negative ion generating pad and the adhesive part is formed on the pad coating part to attach to the pillow, and being constructed in the semicircle pillar-shaped by receiving the vibration generating part and the negative ion generating part.

### TECHNICAL FIELD

The present invention relates to a semicircle pillar-shaped pillow, more specifically relates to the functional semicircle pillar-shaped pillow which self-vibrating with a proper strength to massage the scalp and promote the blood circulation as well as self-generating a negative ion for a long time and purifying a circumstance air to make promotion of health.

### BACKGROUND ART

The spine of a human body protects the spinal code connecting from the brain to the inside of the spine, the spinal code is a nervous system connecting all organs of the human body such as eyes, a nose, the heart, the stomach, the intestines, the kidney or the river with an autonomic nerve to send all information occurring in the outside of the human body to the brain, and to take and deliver the order of the brain.

Accordingly, it is essential for the health of the human body to maintain the body in the natural state, namely original shape of the spine, because the spine of the human body protects the spinal code which is plays an important role in controlling a life function and an immune function between the body and the brain. In addition, the spine plays a role of the pillar supporting the upper part of the boy.

Generally, the spine of the human body is winding in the shape of the S, consisting of the cervical curve from the 1st cervical vertebral to the 7th cervical vertebral, the thoracic curve from the 1st thoracic vertebral to the 12th thoracic vertebral, the lumbar curve from the 1st lumbar vertebral to the 5the lumbar vertebral and the cacral curve from the sacrum to the coccyx.

Accordingly, in order to maintain the vertebrae in a comfortable condition, the human has been used the pillow from ancient times to maintain the vertebrae leading from the back to the neck rightly on lying down for a sleep or a recess, and usually rice husks or synthetic resin materials have been used as a stuffing of the pillow.

Recently, the pillow named as ‘memory foam’ which is consisting of the foam made by foaming the synthetic resin materials has come into wide use, because the conventional pillow does not stably support the neck in the vertebrae.

However, it is a fact that the memory foam of the pillow can stably support the head and the neck, but it can not be achieved entire ventilation such that it has a problem of unsanitary conditions such as the propagation of bacteria or ill-smelling owing to the sweat dropped during a sleep or secreted in the summer.

In addition, various kinds of functional bedclothes have been appearing much, among them functional plastic products having a function related with the health such as magnetic property or far infrared ray generation, antifungal or deodorization function, showing variously. For example, the published Korean Patent Application No.1999-0049582 related to “A functional bedclothes” which is prepared by using the magnetic material. Also, the Korean Utility Model Application No. 2002-0021566 disclosed “A pillow prepared with low elastic polyurethane foam”, which is prepared by mixing powder of tourmaline series or garnet series independently or together with the memory foam and foaming them, but the above Utility Model refers only to effects of negative ion or far infrared ray.

In order to solve such problems, the Korean Patent Application No.20010063794 disclosed “A vibration massage hyperthermo physical therapeutic pillow”, in which the outer shape of the pillow, in contrast with the conventional pillow, has the shape of the part touched with the head, the neck and the shoulder is adopted to the structure of the human body, and the structure of a heating element in the part touched with the neck and the shoulder has the shape of the hemicycle S, and especially, has the heating element part which assortatively generating heat in the part touched with the neck and the shoulder, and has the tube heat generating part of wrinkle shaped being circumscribed with the heating element part, and has the perpendicular vibration massager in a part of the heat element part touched with the both shoulder, has the upper part of the pillow containing an elastic material on the one end of the heat element part, and the built-in part of the controller on the other end of the heat element part, and has the electric circuit part in the one side partition of the built-in part of the controller, and has the automatic cable-winding reel for connecting electric power at the one end of the electric circuit part, and has the air pump room at the one end of the automatic cable-winding reel, and has the air tube for regulating high and low of the upper part of the pillow between the upper part of the pillow and the built-in part of the controller, and has the controlling switching part for electrically controlling the each function of the pillow at the side of the built-in part of the controller.

Also, the Korean Patent Application No.1998-0014600 disclosed “a magnetic pillow combining vibration and timer”, in which in the body of the pillow(10) consisting of the box body(12), as shown in the FIG. 1, many of the magnetic element(16) are arranged on the outer side of the box body(12) and coated with coating article(14), and the vibrator(20) is fitted in the box body(12) and is controlled by the timer(24).

Also, the Korean Patent Application No.2000-0027543 disclosed “A Korean white pine pillow”, in which the pillow, as shown in the FIG. 2, is constructed that the Korean white pine is cut and split to the half in the shape of hemicycle , and is made the barrel which the inside is empty and it's inside is made drawer type capable of open and shut, 40 holes are pierced on the upper side of the pillow laying one's head on(the part of touching with the neck) to the length at interval of 1 cm , and 32 kinds of oriental medicine are placed into the drawer such that it can correct the cervical vertebral, and treat the disease such as headache, neuralgia or toothache.

Also, the Japanese Patent Application No.2001-332943 disclosed the pillow that a filler for the pillow consist of a natural buckwheat peel, and ash of a bamboo and pine resin are added to the buckwheat peel, and the resulting mixture is filled into cover of the pillow, in order to provide a filler for the pillow having effect of moisture absorption, deodorization and generation of far infrared ray and good tactile sensation and permeability for preventing of putrefaction and growth of the mold in perspiration and the pillow using the same.

Also, the Japanese Patent Application No.1999-325861 disclosed the pillow which the external form of the upper part section is formed a convex part with curve based on circle or hemicycle, and the external form of the lower part section is formed by the material of high repelling power with diameter of circle or hemicycle being same or bigger, in order to facilitate customary massaging the blood vessel during the sleep to treat a snore owing to obesity and a cold.

However, the said conventional technology can not satisfy everything in aspect of providing the functional pillow to maintain the vertebra to agreeable situation, to provide a good permeability and to improve the health as using the pillow.

Accordingly, the present inventors are exert all possible efforts on providing the pillow capable of overcoming the above problem in consideration of an all sorts of the above matters and complete the present invention by providing the functional pillow having specific structure.

Disclosure.

Technical Problem.

The present invention is originated in consideration of the above-mentioned matters, and thus the object of the invention is to present the pillow for generating the vibration and the negative ion which maintaining the vertebrae in the most pleasant state, providing excellent permeability and having an additional function to promote the health as a result of using the pillow.

Also, another object of the present invention is to present the pillow for generating the vibration and the negative ion having the above function which can be prepared easily and cheaply with most simple structure.

Another object of the present invention is to present the pillow for generating vibration and negative ion which can be carried out the massage function and the vibration function separately or together.

Another object of the present invention is to present the pillow for generating vibration and negative ion having a function of supporting the neck as well as using in the various part of the human body.

Technical Solution.

In order to accomplish the above objects, the pillow for generating the vibration and the negative ion of the present invention is characterized in comprising the vibration generating part which is constructed by making a regular space in the inside of the pillow, and installing the vibration motor, and connecting the vibrator to the vibration motor; the protrusion part which is formed on regular sites of the vibrator, and protrude out of holes formed on the surface of the pillow with regular height; and the negative ion generating part in which the pad coating part is formed on the upper part of the negative ion generating pad and the adhesive part is formed on the pad coating part to attach to the pillow, and being constructed in the semicircle pillar-shaped by receiving the vibration generating part and the negative ion generating part.

### DESCRIPTION OF DRAWINGS

FIG. 1 is a view showing a conventional magnetic pillow combined vibration and timer;

FIG. 2 is a perspective view showing the Korean white pine pillow of another conventional embodiment;

FIG. 3 is a perspective view showing the semicircle pillar-shaped pillow according to an preferred embodiment of the present invention, and an enlarged cross section view showing the pad-type negative ion generating part attached to the semicircle pillar-shaped pillow;

FIG. 4 is a cross section view showing an inside of the semicircle pillar-shaped pillow installing with the vibration generating part according to the present invention;

FIG. 5 is a perspective view showing the semicircle pillar-shaped pillow according to another embodiment of the present invention in which the pad type negative ion generating part and the massage part are installed in the semicircle pillar-shaped pillow, and enlarged cross section view showing the negative ion generating part;

FIG. 6 is a cross section view showing the inside of the semicircle pillar-shaped pillow installing with the massage part according to present invention;

FIG. 7 is a cross section view showing the inside of the semicircle pillar-shaped pillow according to the present invention;

FIG. 8 is a circuit diagram capable of carrying out and selecting the massage function and the vibration function used in the present invention;

FIG. 9 is a cross section view showing the semicircle pillar-shaped pillow used in the present invention;

FIG. 10 is a cross section view showing another example of the pillow according to the present invention;

FIG. 11 is a cross section view showing another example of the pillow according to the present invention;

FIG. 12 is a cross section view showing another example of the pillow according to the present invention.

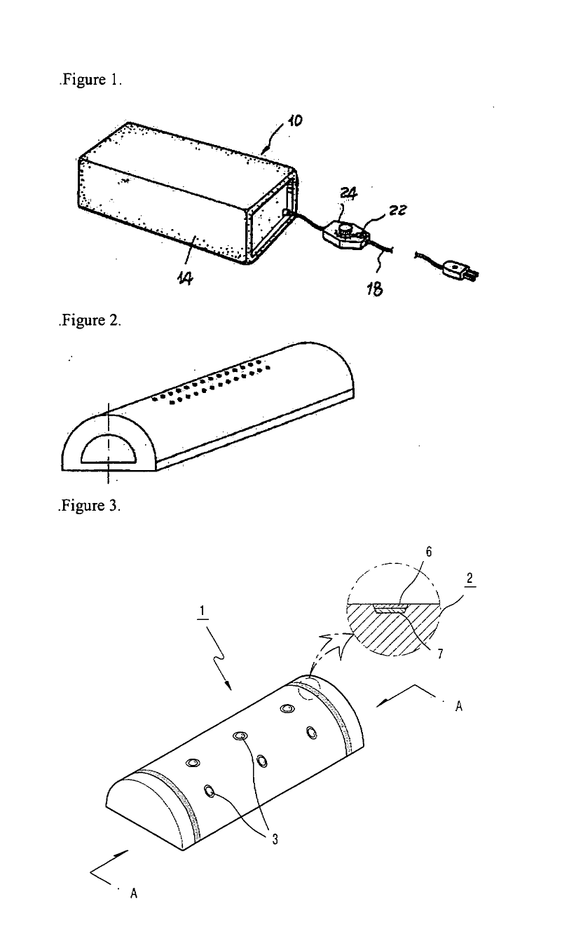

### Explanation of a symbol in the principal part of drawings

1 The pillow body

2 the negative ion generating part

3 The protrusion part

4 the vibrator

5 The vibration motor

6 the pad coating part

7 The pad type negative ion generating part

31 the massage part

### BEST MODE

In the following descriptions, examples of the present invention are explained in greater detail by referring to the attached drawings.

FIG. 3 is a perspective view showing the semicircle pillar-shaped pillow according to the preferred embodiment of the present invention, and an enlarged cross section view showing the pad-type negative ion generating part attached to the semicircle pillar-shaped pillow.

The semicircle pillar-shaped pillow (1) has the negative ion generating part (2) n the shape of long belt at the right and left side, and the negative ion generating part (2) is constructed by forming the pad coating part (6) on the upper side of the negative ion generating pad part (7).

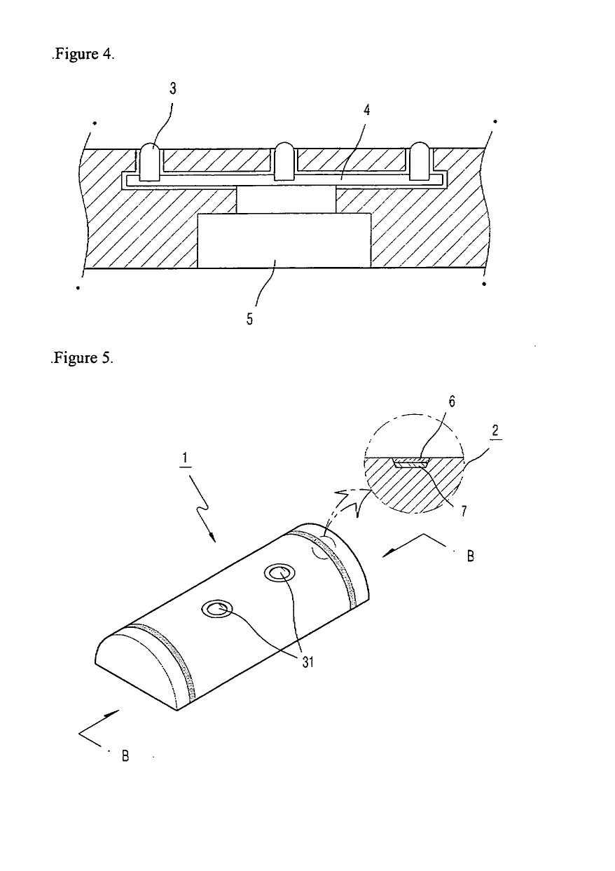

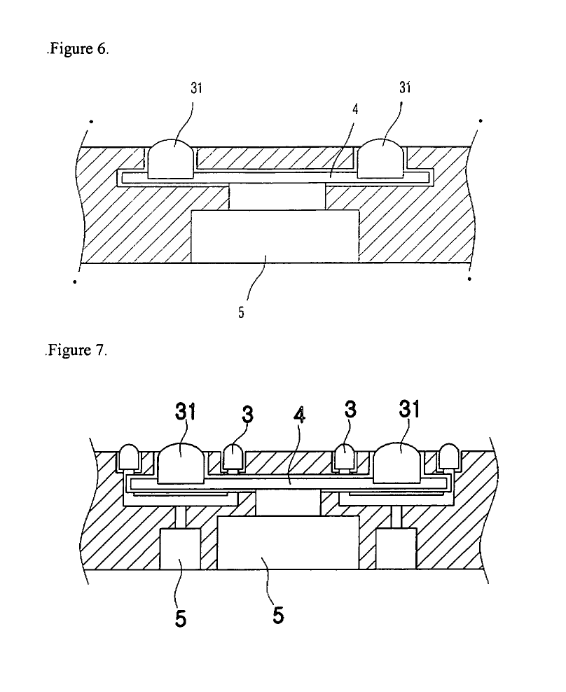

Additionally, many of the protrusion part (3) are formed on the semicircle pillar-shaped pillow (1), and the protrusion part (3) and the vibration generating part are as described in FIG. 4 hereinafter.

The vibration generating part is constructed by making a regular space in the inside of the pillow, and installing with the vibration motor (5), and connecting the vibrator (4) with the vibration motor (5).

Additionally, the protrusion part (3) is formed on the regular sites of the vibrator (4) and protrudes out of holes formed on the surface of the pillow with regular height.

The negative ion generating part (2), as detailed described in FIG. 3, has the adhesion part for adhering to the pillow, and is constructed with the negative ion generating body part (7), and the adhesion part is adhering to the negative ion generator adhesion part.

The pillow of the present invention is constructed to have the semicircle pillar shape with receiving the vibration generating part and the negative ion generating part.

FIG. 5 is a perspective view showing the semicircle pillar-shaped pillow according to another embodiment of the present invention in which the pad type negative ion generating part and the massage part are installed to the semicircle pillar-shaped pillow, enlarged cross section view showing the negative ion generating part.

According to such construction, the negative ion generating part (2) is formed of a belt-typed pad (7) and is attached to adhesion part for the negative ion generating part formed on the body of the pillow, and a pad coating part (6) coated with porous material for controlling the generation amount of the negative ion can be formed on the pad.

The negative ion generating pad according to the present invention preferably can be made by mixing and treating a generally known negative ion generating powder and forming it into the pad shape and can be used with the shape of belt-typed pad. More preferably, the negative ion generating pad can be used by coating the surface with coating element consisting of porous material.

According to another aspect of the present invention, the vibration generating part can be constructed to have a function of massaging the meridian pathways of the neck by getting the massage part (31) having the semicircle type end of over regular size to do a elliptic motion with regular speed to the up-and-down and the right-and-left by motor (5).

Additionally, the massage function and the vibration function can be combined to be used together.

In FIG. 7, there is showing the construction that the massage function and the vibration function are combined.

As shown by FIG. 7, there is the vibration generating part that a regular space is formed in the inside of the pillow, and the vibration motor (5) is installed, and the vibrator (4) is connected to the vibration motor (5).

Also, the vibration generating part has the massage part (31) and many of the protrusion parts (3), and the massage part (31) has an end of over the regular size and is constructed to do an elliptic motion with regular speed to the up-and-down and the right-and-left.

Also, the protrusion part (3) are arranged nearly at the both side of the massage part (31), and is constructed to connect to the vibrator, and protrude out of holes formed on the surface of the pillow with the regular height.

As such, the protrusion part (3) are arranged at the both side of the massage part (31) such that there can be expected to show more superior effects on stimulating the blood vessel of the neck to promote the blood circulation by carrying out the massage function and the vibration function at the same time.

Namely, a massage pole stimulates a sunken-in region of the neck part, and the protrusion part (3) gives the vibration to tendon regions at the both side of the sunken-in region.

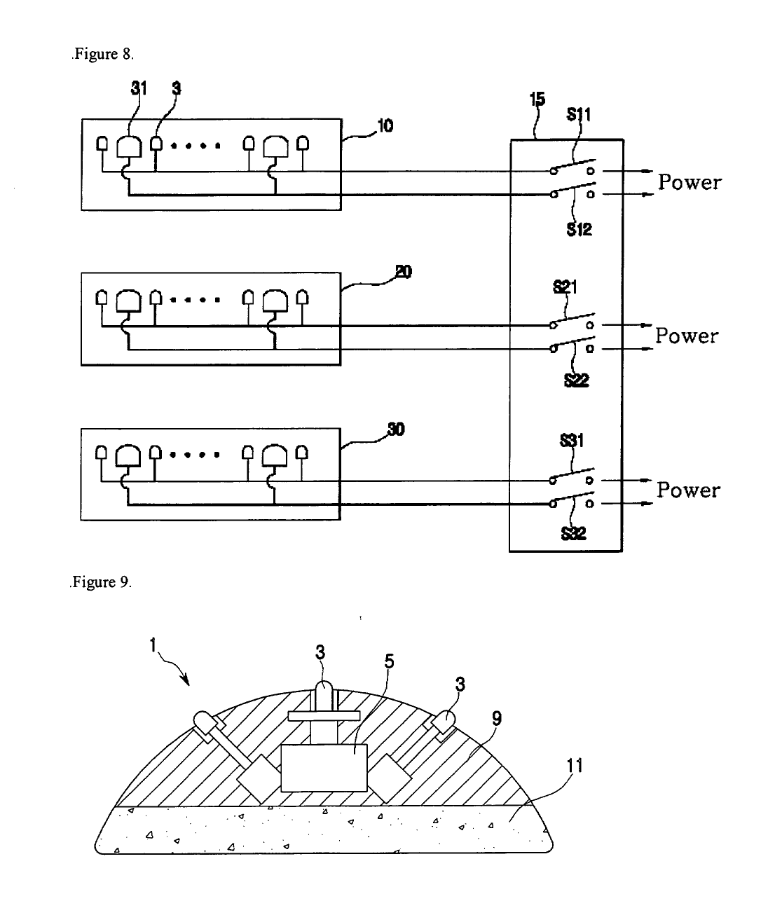

In FIG. 8, a circuit capable of carrying out and selecting the massage function and the vibration function at the same time used in the present invention is shown.

The pillow of the present invention consists of the first driving part (10), the second driving part (20) and the third driving part (30), and each driving part have the protrusion part (3) and the massage part (31).

The protrusion part (3) and the massage part (31) are connected to the motor via the vibrator, but this is not shown in Figure, and each driving part are connected to the power supply via switches (S11), (S12), S(21), S(22), S(31) and (S32) of a switch part (15).

As selecting of switch (S11), the protrusion part (3) in the first driving part (10) is driven to vibrate, and as selecting of switch (S12), the massage part (31) carry out its massage function, and as selecting of switches (S11) and (S12), the massage function and the vibration function are carried out at the same time.

Each switch in the second driving part (20) and the third driving part (30) is driven identically like the above switch.

FIG. 9 is the cross section view showing the semicircle pillar-shaped pillow according to the present invention.

A material for the semicircle pillar-shaped pillow according to the present invention are not restricted to the specific material, preferably, a hard wood or plastic, a compressed coconut palm peels or a hard sponge can be used. In this way, it is possible to prevent the sweat from coming out and to maintain the neck uprightly.

Especially, a inside lower part (11) in the body of the pillow which receiving the vibration generating part and the negative ion generating part of the semicircle pillar-shaped pillow (1) is filled with oriental medicines or small and minute particle elements, and a scent of ingredient from oriental medicines is volatilized to give effects like an aroma. Also, as small and minute particle elements are filled in the pillow, in case of weight of the neck coming to add at the pillow, it can be functioned as cushion and it can be offered the condition(the condition of friction) to be well adhered a lower face and the pillow.

According to another aspect of the present invention, it is possible to generate the negative ion from the pillow itself by mixing the general negative ion generating material with the regular ratio into the semicircle pillar-shaped pillow material (9) according to the present invention such as a hard wood or plastic, a compressed coconut palm peels, a hard sponge in preparing the pillow of the present invention.

Namely, the pillow of the present invention can be prepared by mixing the semicircle pillar-shaped pillow material according to the present invention such as a hard wood or plastic, compressed coconut palm peels, a hard sponge into the general negative ion generating material with the regular ratio.

By such construction of the pillow, it can be generating the negative ion regularly without additional installation of the negative ion generating part.

Also, it can be possible to generate the negative ion by wrapping the semicircle pillar-shaped pillow according to the present invention with non-woven fabric in which the negative ion generating material is mixed with the regular ratio.

Moreover, it can be preferred to wrap the semicircle pillar-shaped pillow according to the present invention with the pillow cover made by a proper cotton material.

According to another aspect of the present invention, the size of the semicircle pillar-shaped pillow according to the present invention is not restricted to the specific size, generally it can be possible to prepare the pillow with a height of 3 to 20 cm and to be used as the pillow having a size suitable to each one of an infant or an adult.

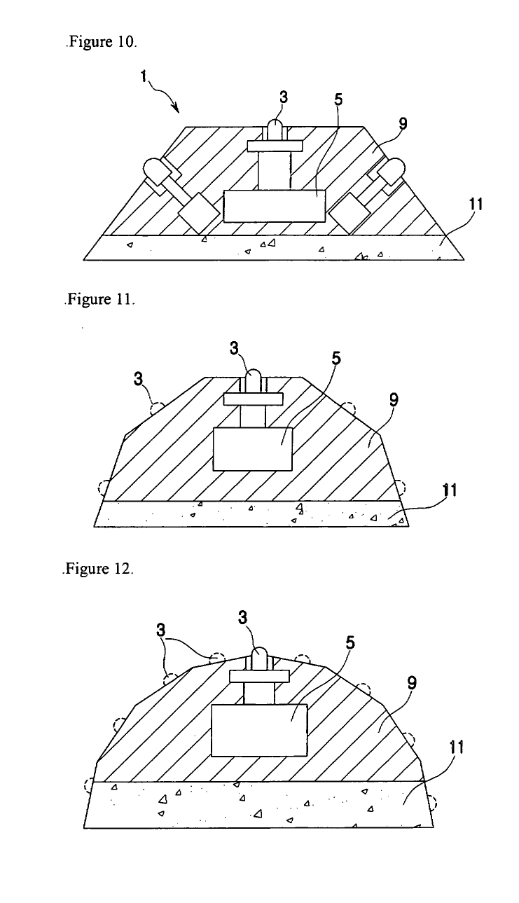

In FIG. 10 to 12, there is shown to another embodiment of the pillow according to the present invention, in which as detailed described in the above, the semicircle pillar-shaped pillow having a modified shape is demonstrated.

Namely, the body of the pillow which receiving the vibration generating part and the negative ion generating part can be constructed by any one of a pentagon, a hexagon, an octagon or a trapezoid.

By means of applying the trapezoid to the pillow as shown in FIG. 10, it can be possible to solve the problem like that, as the inside material (9) of the pillow is made up of the hard material, it has difficulty in receiving elasticity and can be rather high than the semicircle pillar-shaped pillow so that the pillow must be used by more higher.

Also, in case of the pentagon (FIG. 11) and hexagon pillow, these pillows have excellent effects on using by putting them between the intervals which a joint of the arm or the leg bends.

Hence, the massage part in which the massage pole is formed and the protrusion part to which vibration is given, are formed in the region of making the angle in the above square shape, as detailed described in above, and thus the massage function and the vibration function are given to various fields of the human body.

Also, in case the pillow of the present invention is constructed in the shape of the octagonal pillar as shown in FIG. 12, as an interior angle is nearly the same as an circle, it has an effect that the massage and vibration force from various angles can be present on putting the pillow on the abdomen and using it in state of lying prone.

The present invention as set forth above has effects as followings: Generally, corpuscle or molecule not to be seen to eyes such as an oxygen, carbon gas, nitrogen and hydrogen etc., wander in the air, and those can be exist in the form of the positive ion which losing the electron and having plus electricity, and the negative ion which obtaining the electron and having minus electricity. Usually, the negative ion has effects to remove a bad smell, to purify the air by precipitating organic materials, and to remove harmful electromagnetic waves. Namely, a refreshment to be felt in a forest, an waterfall or a spring is due to the negative ion in the air, if breathing the negative ion, it have effects to promote metabolism of cells, to enhance a vitality, to make the blood clean, to calm nerves, to recover the fatigue, and to improve an appetite.

Also, the pillow of the present invention has effects by containing the vibration generating part that it can continuously massage the neck of the user to stimulate the blood vessel of the neck, and thus that it can be possible to enhance the blood circulation and to recover the fatigue as soon as possible and to make a head fresh by supplying an oxygen to a brain, and to make promotion of health.

### INDUSTRIAL APPLICABILITY

The hemicycle pillow of the present invention has effects on removing a bad smell, purifying the air and eliminating electromagnetic waves injurious the human body by means of the negative ion generating part to generate the negative ion continuously, and on promoting the circulation of the blood to make promotion of health by means of the vibration generating part to massage the blood vessel of the neck. In addition, the hemicycle pillow has a function of protecting the neck bone while asleep as being made by hard material to the hemicycle shape, as well as has superior ventilation facility of preventing the pillow being moisturized by sweat though the user who is sweating much such that it is beneficial for the reason of sanitation.

1. A pillow for generating vibration and negative ion, comprising the vibration generating part which is constructed by making a regular space in the inside of the pillow, and installing the vibration motor, and connecting the vibrator to the vibration motor; the protrusion part which is formed on regular sites of the vibrator, and protrude out of holes formed on the surface of the pillow with regular height; and the negative ion generating part in which the pad coating part is formed on the upper part of the negative ion generating pad and the adhesive part is formed on the pad coating part to attach to the pillow, and being constructed in the semicircle pillar-shaped by receiving the vibration generating part and the negative ion generating part.

2. The pillow according the claim 1, wherein the negative ion generating part is formed in belt shaped pad to attach to the adhesive part which formed in main body of the pillow, the pad is coated with porous material capable of controlling the amount of the negative ion generation.

3. The pillow according the claim 1, wherein the belt shaped pad of the negative ion generating part is made to the shape of pad by mixing the powder to generate the negative ion in the liquid phase.

4. The pillow according the claim 1, wherein the vibration generating part has the massage part (31) having the hemicycle end over the regular size is in elliptic motion at fixed speed to the up-and-down and right-and-left by motor (5) to massage the blood vessel of the neck of the user.

5. The pillow according the claim 1 to 4, wherein the main body of the pillow is made by any one of the hard wood or plastic, the compressed coconut palm peels, or the hardened sponge.

6. The pillow according the claim 5, wherein the powder of generating the negative ion is mixed with the regular ratio on preparing the main body of the pillow made by the compressed coconut palm peels.

7. The pillow according the claim 1, wherein the inside lower part in the body of the pillow receiving the vibration generating part and the negative ion generating part of the pillow is filled with oriental medicines or small and minute particle elements.

8. The pillow according the claim 1, wherein the body of the pillow receiving the vibration generating part and the negative ion generating part is constructed by any one of a pentagon, a hexagon, an octagon or a trapezoid.

9. A pillow for generating vibration and negative ion, comprising the vibration generating part which is constructed by making a regular space in the inside of the pillow, and installing the vibration motor, and connecting the vibrator to the vibration motor; the massage part having the half-circle type end of more than regular size by motor to do a elliptic motion with regular speed to the up-and-down and the right-and-left; the protrusion part which is arranged nearly at the both side of the massage part, and is protruded out of holes formed on the surface of the pillow with regular height; the switch part selected by the motor driving the massage part and the protrusion part; and the negative ion generating part in which the pad coating part is formed on the upper part of the negative ion generating pad and the adhesive part is formed on the pad coating part to attach to the pillow, and being constructed in the semicircle pillar-shaped by receiving the vibration generating part and the negative ion generating part.

10. The pillow according the claim 9, wherein the body of the pillow receiving the vibration generating part and the negative ion generating part is constructed by any one of a pentagon, a hexagon, an octagon or a trapezoid.
